(19) United States
(12) Patent Application Publication
(10) Pub. No.: US 2014/0106243 A1
(43) Pub. Date: Apr. 17, 2014

(54) FUEL CELL

(71) Applicants: Shinobu Takenaka, Osaka-shi (JP); Mutsuko Komoda, Osaka-shi (JP); Tomohisa Yoshie, Osaka-shi (JP); Hirotaka Mizuhata, Osaka-shi (JP); Takenori Onishi, Osaka-shi (JP); Masashi Muraoka, Osaka-shi (JP)

(72) Inventors: Shinobu Takenaka, Osaka-shi (JP); Mutsuko Komoda, Osaka-shi (JP); Tomohisa Yoshie, Osaka-shi (JP); Hirotaka Mizuhata, Osaka-shi (JP); Takenori Onishi, Osaka-shi (JP); Masashi Muraoka, Osaka-shi (JP)

(73) Assignee: C/O SHARP KABUSHIKI KAISHA, Osaka-shi, Osaka (JP)

(21) Appl. No.: 14/118,883

(22) PCT Filed: May 23, 2012
(86) PCT No.: PCT/JP2012/063141

§ 371 Date: Nov. 19, 2013

(30) Foreign Application Priority Data
May 24, 2011 (JP) 2011-115874

(51) Int. Cl. H01M 8/04

(52) U.S. Cl. CPC H01M 8/04291
USPC 429/408; 429/482

(57) ABSTRACT

A fuel cell including a unit cell having an anode, an electrolyte membrane, and a cathode in this order, a liquid fuel accommodation portion composed of a space opening on an anode side and arranged on the anode side, for accommodating or allowing flow of liquid fuel, and a first moisture retention layer arranged between the unit cell and the liquid fuel accommodation portion is provided. This fuel cell may further include a second moisture retention layer arranged on the cathode. This fuel cell can be a direct alcohol fuel cell. For example, pure methanol or a methanol aqueous solution is adopted as the liquid fuel.

### TECHNICAL FIELD

The present invention relates to a fuel cell.

### BACKGROUND ART

Expectations for practical use of a fuel cell as a novel power supply for portable electronic devices supporting the information-oriented society have been growing. Fuel cells are categorized into a phosphoric acid type, a molten carbonate type, a solid electrolyte type, a polymer electrolyte type, a direct alcohol type, and the like, depending on a category of an electrolyte material or fuel to be used. In particular, a polymer electrolyte fuel cell including as an electrolyte material, an ion-exchange membrane which is a solid polymer and a direct alcohol fuel cell can achieve high power generation efficiency at room temperature, and hence practical use thereof as a small fuel cell directed to application to portable electronic devices has been studied.

For such a reason that a fuel storage chamber of a direct alcohol fuel cell using alcohol or an alcohol aqueous solution as fuel can be designed relatively more easily than in a case that a gas is used as fuel, simplification of a structure of a fuel cell and space conservation can be achieved, and such a fuel cell is particularly highly expected to serve as a small fuel cell directed to application to portable electronic devices.

In a direct alcohol fuel cell including a cation-exchange membrane (a proton conductive film) as an electrolyte membrane, as fuel (alcohol or an alcohol aqueous solution) is supplied to an anode, fuel is oxidized and a gas such as carbon dioxide and protons are generated. For example, in a case that methanol is employed as alcohol, carbon dioxide is generated on an anode side as a by-product gas through oxidation reaction below.

CH₃OH+H₂O→CO₂↑+6H⁺+6e⁻ (1)

Protons generated on the anode side are conducted to a cathode side through an electrolyte membrane. Then, protons and an oxidizing agent (such as air) supplied to the cathode go through reduction reaction below and water is generated.

3/2O₂+6H⁻+6e→3H₂O (2)

Here, electrons pass through an external electronic device (a load) and migrate from the anode to the cathode, so that electric power is extracted.

A fuel cell using fuel in a liquid state (hereinafter referred to as liquid fuel), such as a direct alcohol fuel cell, includes a liquid supply type in which liquid fuel is supplied as it is to an anode and a vaporization supply type in which a vaporized component of liquid fuel is supplied to an anode. For example, International Publication WO2008/023633 (PTD 1) discloses a fuel cell of a vaporization supply type in which a gas-liquid separation membrane allowing passage of vaporized fuel (hereinafter referred to as vaporized fuel) is arranged between a liquid fuel accommodation chamber and an anode and a vaporized fuel supply chamber is formed between the gas-liquid separation membrane and the anode.

### CITATION LIST

### Patent Document

PTD 1: International Publication WO2008/023633

### SUMMARY OF INVENTION

### Technical Problem

In order to realize a small fuel cell directed to application to portable electronic devices and the like, a fuel cell has been demanded to achieve further improvement in power generation characteristics. Then, an object of the present invention is to provide a fuel cell achieving improved power generation characteristics, in which water is generated at a cathode along with power generation, such as a direct alcohol fuel cell.

### Solution to Problem

The present inventors have found as a result of dedicated studies that, by arranging a moisture retention layer on an anode, water generated at a cathode [see formula (2) above] and returned to the anode through an electrolyte membrane can satisfactorily be retained within the anode without transpiration of the water to the outside of a unit cell, so that the water is effectively made use of for reaction at the anode [see formula (1) above] and consequently high power generation characteristics can be obtained in a stable manner.

Namely, the present invention includes the following.

[1] A fuel cell, including

a unit cell having an anode, an electrolyte membrane, and a cathode in this order,

a liquid fuel accommodation portion composed of a space opening on a side of the anode and arranged on the side of the anode, for accommodating or allowing flow of liquid fuel, and

a first moisture retention layer arranged between the unit cell and the liquid fuel accommodation portion.

[2] The fuel cell according to [1], further including a second moisture retention layer arranged on the cathode.

[3] The fuel cell according to [1], wherein

the unit cell further includes an anode current collection layer stacked on the anode and a cathode current collection layer stacked on the cathode.

[4] The fuel cell according to [3], wherein

the first moisture retention layer is arranged on the anode current collection layer so as to be in contact with the anode current collection layer.

[5] The fuel cell according to [3], further including a second moisture retention layer arranged on the cathode, wherein

the second moisture retention layer is arranged on the cathode current collection layer so as to be in contact with the cathode current collection layer.

[6] The fuel cell according to [3], further including a second moisture retention layer arranged on the cathode, wherein

the first moisture retention layer is arranged on the anode current collection layer so as to be in contact with the anode current collection layer, and

the second moisture retention layer is arranged on the cathode current collection layer so as to be in contact with the cathode current collection layer.

[7] The fuel cell according to any of [1] to [6], further including

a gas-liquid separation layer arranged over the liquid fuel accommodation portion so as to cover an opening of the liquid fuel accommodation portion and allowing a vaporized component of the liquid fuel to permeate, and

a vaporized fuel accommodation portion composed of a space formed between the gas-liquid separation layer and the first moisture retention layer.

[8] The fuel cell according to [7], wherein

the gas-liquid separation layer has a two-layered structure constituted of a first layer arranged over the liquid fuel accommodation portion so as to cover the opening of the liquid fuel accommodation portion and having a bubble point not lower than 30 kPa with methanol being adopted as a measurement medium and a second layer stacked on a surface of the first layer on a side of the unit cell and allowing a vaporized component of the liquid fuel to permeate.

[9] The fuel cell according to any of [1] to [8], wherein

the fuel cell is a direct alcohol fuel cell.

[10] The fuel cell according to [9], wherein

the liquid fuel is pure methanol or a methanol aqueous solution.

### Advantageous Effects of Invention

According to the present invention, by providing the first moisture retention layer on the anode side, water generated at the cathode and returned to the anode through the electrolyte membrane can effectively be made use of for reaction at the anode without transpiration of the water from the anode side to the outside of the unit cell. Therefore, a fuel cell exhibiting high power generation characteristics in a stable manner can be provided. The fuel cell according to the present invention is suitable as a small fuel cell directed to application to portable electronic devices, among others, as a small fuel cell for mount on portable electronic devices.

### BRIEF DESCRIPTION OF DRAWINGS

FIG. 1 is a schematic cross-sectional view showing one example of a fuel cell according to the present invention.

FIG. 2 is a schematic top view of the fuel cell shown in FIG. 1.

FIG. 3 is a schematic cross-sectional view along the line shown in FIG. 1.

FIG. 4 is a schematic cross-sectional view along the line IV-IV shown in FIG. 1.

FIG. 5 is a schematic cross-sectional view along the line V-V shown in FIG. 1.

FIG. 6 is a schematic top view and a schematic cross-sectional view showing a vaporized fuel plate included in the fuel cell shown in FIG. 1.

FIG. 7 is a schematic top view and a schematic cross-sectional view showing another example of a vaporized fuel plate.

FIG. 8 is a schematic cross-sectional view showing another example of a fuel cell according to the present invention.

FIG. 9 is a schematic top view showing a third layer included in the fuel cell shown in FIG. 8.

FIG. 10 is a schematic cross-sectional view showing another example of a liquid fuel accommodation portion.

FIG. 11 is a schematic cross-sectional view showing another example of a liquid fuel accommodation portion.

FIG. 12 is a schematic cross-sectional view showing another example of a fuel cell according to the present invention.

FIG. 13 is a schematic cross-sectional view showing another example of a fuel cell according to the present invention.

FIG. 14 is a schematic top view showing a box housing employed in Example 1.

FIG. 15 is a diagram showing results of I-V measurement of fuel cells fabricated in Example 1 and Comparative Example 1.

### DESCRIPTION OF EMBODIMENTS

A fuel cell according to the present invention will be described hereinafter in detail with reference to an embodiment.

### First Embodiment

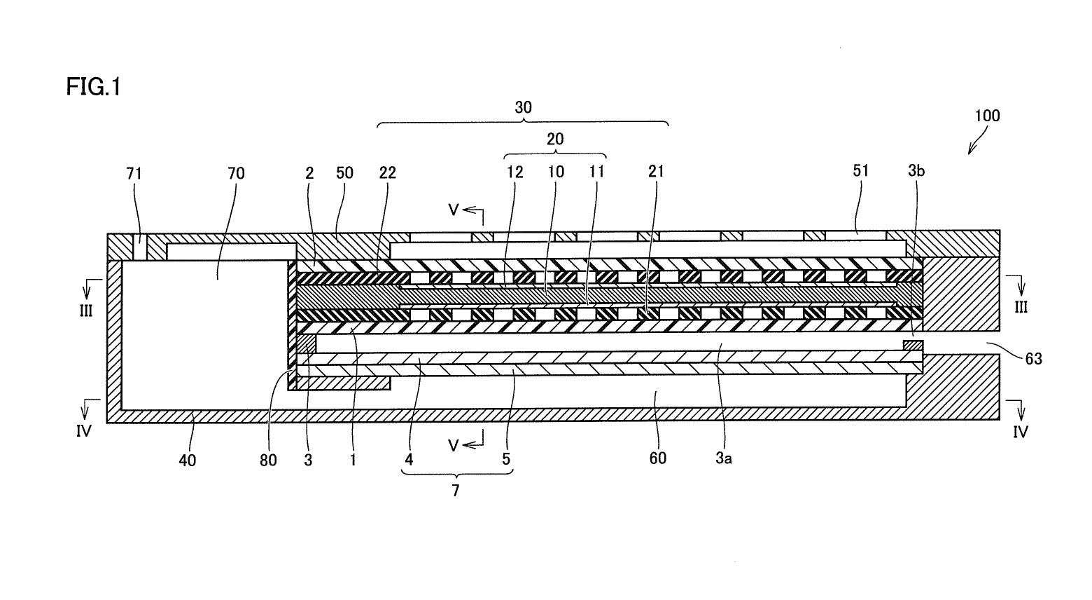

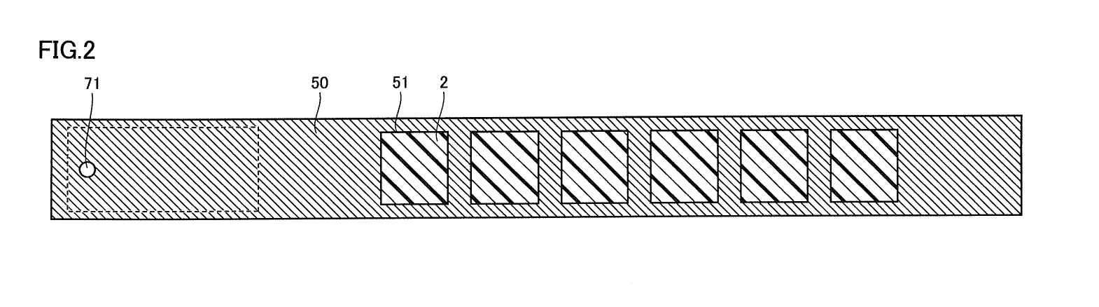

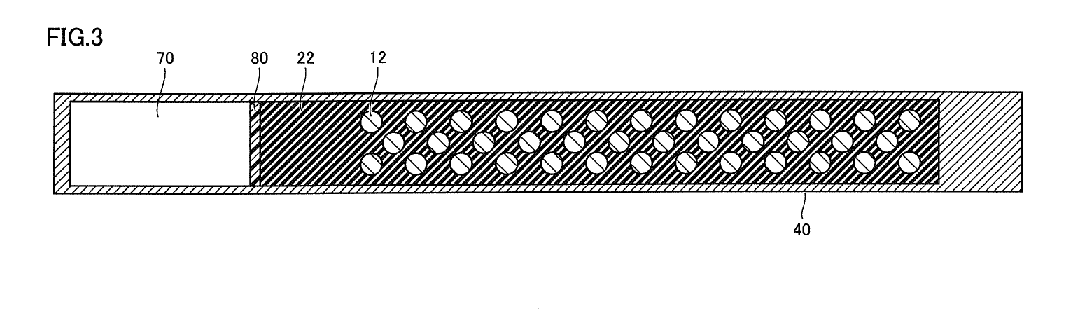

FIG. 1 is a schematic cross-sectional view showing a fuel cell in the present embodiment and FIG. 2 is a schematic top view of the fuel cell. In addition, FIGS. 3 to 5 show cross-sectional views along the lines III-III, IV-IV, and V-V shown in FIG. 1, respectively. A fuel cell 100 in the present embodiment shown in these drawings is basically constituted of: a unit cell 30 including a membrane electrode assembly 20 including an anode 11, an electrolyte membrane 10, and a cathode 12 in this order, an anode current collection layer 21 stacked on anode 11 and electrically connected thereto, and a cathode current collection layer 22 stacked on cathode 12 and electrically connected thereto; a liquid fuel accommodation portion 60 arranged below anode 11 and composed of a space opening on an anode 11 side; a first moisture retention layer 1 stacked on anode current collection layer 21 so as to be in contact with anode current collection layer 21, between unit cell 30 and liquid fuel accommodation portion 60; a second moisture retention layer 2 stacked on cathode current collection layer 22 so as to be in contact with cathode current collection layer 22; a gas-liquid separation layer 7 arranged over liquid fuel accommodation portion 60 so as to cover an opening of liquid fuel accommodation portion 60 (a surface opening to the anode side); a vaporized fuel accommodation portion 3a composed of a space formed between gas-liquid separation layer 7 and first moisture retention layer 1; and a fuel storage portion 70 for storing liquid fuel (not shown).

In fuel cell 100 in the present embodiment, vaporized fuel accommodation portion 3a is formed by interposing a vaporized fuel plate 3 between first moisture retention layer 1 and gas-liquid separation layer 7. Vaporized fuel plate 3 has vaporized fuel accommodation portion 3a which is a through port passing through in a direction of thickness and a communication path 3b communicating vaporized fuel accommodation portion 3a and the outside of vaporized fuel plate 3 with each other.

Gas-liquid separation layer 7 has a two-layered structure of a first layer 5 arranged over liquid fuel accommodation portion 60 so as to cover the opening of liquid fuel accommodation portion 60 and a second layer 4 stacked on a surface of first layer 5 on a side of unit cell 30 and allowing a vaporized component of the liquid fuel to permeate.

Liquid fuel accommodation portion 60 for allowing the liquid fuel to flow is constituted of a box housing 40 having a recess (a groove) forming the same and gas-liquid separation layer 7 stacked to cover the opening of liquid fuel accommodation portion 60. Box housing 40 integrally has a site forming a bottom wall and sidewalls of fuel storage portion 70, together with a site forming liquid fuel accommodation portion 60. Liquid fuel accommodation portion 60 and fuel storage portion 70 are connected to each other through a flow path.

Fuel cell 100 in the present embodiment includes, together with box housing 40, a lid housing 50 stacked on second moisture retention layer 2 and having a plurality of openings 51. Lid housing 50 integrally has a site forming an upper wall (a ceiling wall) of fuel storage portion 70, together with a site stacked on second moisture retention layer 2, and fuel storage portion 70 is formed from box housing 40, lid housing 50, and side surfaces of unit cell 30 and the like. As shown in FIG. 1, on end surfaces of unit cell 30 and the like on a side of the fuel storage portion, a sealing layer 80 consisting of a layer or the like of a cured product of an epoxy-based curing resin composition is formed to prevent liquid fuel stored in fuel storage portion 70 from entering. In fuel cell 100 in the present embodiment, fuel storage portion 70 is arranged lateral to unit cell 30 and liquid fuel accommodation portion 60 arranged below the unit cell.

Box housing 40 includes a first open hole 63 connected to communication path 3b of vaporized fuel plate 3. In addition, fuel storage portion 70 includes a second open hole 71 communicating an internal space thereof and the outside of fuel cell 100 with each other. This second open hole 71 is a through hole provided in lid housing 50.

Fuel cell 100 in the present embodiment generates electric power through the following operations. Liquid fuel which has flowed through a flow path from fuel storage portion 70 into liquid fuel accommodation portion 60 and wetted gas-liquid separation layer 7 is subjected to gas-liquid separation by gas-liquid separation layer 7 and only a vaporized component (vaporized fuel) of the liquid fuel permeates toward vaporized fuel accommodation portion 3a. The vaporized fuel passes through first moisture retention layer 1 and then an opening in anode current collection layer 21, and it is supplied to anode 11. When a methanol aqueous solution is exemplified as liquid fuel, the methanol aqueous solution in a gaseous state supplied to anode 11 goes through oxidation reaction expressed with a formula below and then it is consumed.

CH₃OH+H₂O→CO₂↑+6H⁺+6e⁻

Though the vaporized fuel is consumed in accordance with an amount of current in power generation by fuel cell 100, liquid fuel continues to evaporate at any time through gas-liquid separation layer 7 for compensation, and hence a vapor pressure of the vaporized fuel in the vicinity of anode 11 is kept substantially constant.

On the other hand, at cathode 12, an oxidizing agent (such as air) which has arrived through opening 51 in lid housing 50, second moisture retention layer 2, and then the opening in cathode current collection layer 22 and protons conducted from anode 11 to cathode 12 through electrolyte membrane 10 go through reduction reaction expressed with the formula below.

3/2O₂+6H⁻+6e⁻÷3H₂O

Through the oxidation-reduction reaction above, electrons migrate along a route of anode 11→anode current collection layer 21→external electronic device (load)→cathode current collection layer 22→cathode 12, and electric power is supplied to the external electronic device.

Gas-liquid separation layer 7 and vaporized fuel plate 3 arranged between liquid fuel accommodation portion 60 and unit cell 30 allows uniform fuel supply to anode 11 in such a state that control to an appropriate amount is achieved. Namely, as fuel passes through gas-liquid separation layer 7 and vaporized fuel accommodation portion 3a of vaporized fuel plate 3, an amount or a concentration of the fuel is adjusted to be within an appropriate range, and uniformity of the amount or concentration is promoted. Thus, crossover of fuel can effectively be suppressed, temperature variation in a power generation portion is less likely, and a stable power generation state can be maintained.

Each member or the like forming fuel cell 100 will now be described in detail.

[First Moisture Retention Layer]

First moisture retention layer 1 is a layer arranged between unit cell 30 and liquid fuel accommodation portion 60 (vaporized fuel accommodation portion 3a, in a case that vaporized fuel accommodation portion 3a is provided as in the present embodiment), for preventing transpiration of moisture in anode 11 from the anode 11 side to the outside of unit cell 30 (for example, to vaporized fuel accommodation portion 3a) and retaining the moisture within anode 11. According to fuel cell 100 in the present embodiment including first moisture retention layer 1, water which has been generated at cathode 12 and reached anode 11 through electrolyte membrane 10 can satisfactorily be retained within anode 11 without transpiration of the same to the outside of unit cell 30. Since water is thus effectively made use of for reaction at anode 11, reaction efficiency at anode 11 improves and high power generation characteristics can be exhibited in a stable manner. Among others, by providing second moisture retention layer 2 also on the cathode 12 side, the effect can more effectively be obtained.

In addition, there is also an advantage that, with improvement in reaction efficiency at anode 11, even when fuel at a high concentration is employed (a high concentration means that a methanol concentration is high, for example, when a methanol aqueous solution is employed as fuel), crossover of the fuel is less likely. As high-concentration fuel can be employed, reduction in capacity of liquid fuel accommodation portion 60 and fuel storage portion 70 and hence further reduction in size of a fuel cell can be achieved.

Moreover, it is extremely effective to provide first moisture retention layer 1 and second moisture retention layer 2 which will be described later in preventing drying of electrolyte membrane 10 and accompanying increase in cell resistance and lowering in power generation characteristics.

First moisture retention layer 1 is composed of a material which is gas-permeable so as to allow vaporized fuel or the like to permeate and insoluble in water and has a moisture retention property (a property not to allow transpiration of water). Specifically, first moisture retention layer 1 can be a porous film (a porous layer) composed of a fluorine-based resin such as polyvinylidene fluoride (PVDF) and polytetrafluoroethylene (PTFE); an acrylic resin; a polyolefin-based resin such as polyethylene and polypropylene; a polyester-based resin such as polyethylene terephthalate; a polyurethane-based resin; a polyamide-based resin; a polyacetal-based resin; a polycarbonate-based resin; a chlorine-based resin such as polyvinyl chloride; a polyether-based resin; a polyphenylene-based resin; a silicone resin subjected to water-repellent treatment; and the like. First moisture retention layer 1 can be a foam, a fiber bundle, woven fibers, non-woven fibers composed of a polymer above, combination thereof, or the like.

First moisture retention layer 1 desirably has such gas permeability as allowing vaporized fuel, a by-product gas (a CO₂ gas or the like) generated in a catalyst layer, and the like to permeate and a moisture retention property (a property not allowing transpiration of water), and therefore, first moisture retention layer 1 has a porosity preferably not lower than 50% and not higher than 90% and more preferably not lower than 60% and not higher than 80%. When a porosity of first moisture retention layer 1 exceeds 90%, it becomes difficult to retain within unit cell 30, water which has been generated at cathode 12 and reached anode 11 through electrolyte membrane 10, and there may be a case that high power generation characteristics cannot be exhibited in a stable manner. On the other hand, when a porosity of first moisture retention layer 1 is lower than 50%, diffusion of vaporized fuel, a by-product gas (a CO₂ gas or the like) generated in a catalyst layer, and the like is interfered, and power generation characteristics at anode 11 tend to lower. A porosity of a moisture retention layer can be calculated by finding specific gravity of the moisture retention layer by measuring a volume and a weight of the moisture retention layer and finding a porosity based on the specific gravity and specific gravity of a source material in accordance with the following equation.

Porosity (%)=[1−(specific gravity of moisture retention layer/specific gravity of source material)]×100

Though a thickness of first moisture retention layer 1 is not particularly restricted, in order to sufficiently express the function above, the thickness is preferably not smaller than 20 μm and more preferably not smaller than 50 μm. In addition, from a point of view of a smaller thickness of a fuel cell, first moisture retention layer 1 has a thickness preferably not greater than 500 μm and more preferably not greater than 300 μm.

First moisture retention layer 1 preferably has water repellency, because the first moisture retention layer itself desirably has high water absorbability but does not have such a property as taking in water once absorbed in a liquid state and then not releasing the water to the outside. From such a point of view, first moisture retention layer 1 is preferably a porous film (a porous layer) composed of: a fluorine-based resin such as polyvinylidene fluoride (PVDF) and polytetrafluoroethylene (PTFE); a silicone resin subjected to water-repellent treatment; and the like. Specifically, TEMISH®, “NTF2026A-N06” or “NTF2122A-S06”, manufactured by Nitto Denko Corporation, which is a porous film composed of polytetrafluoroethylene, can be exemplified.

First moisture retention layer 1 is preferably stacked on anode current collection layer 21 so as to be in contact with this anode current collection layer 21, by arranging anode current collection layer 21 on anode 11. Thus, transpiration of moisture in anode 11 to the outside of unit cell 30 can more effectively be prevented.

[Second Moisture Retention Layer]

Second moisture retention layer 2 is a layer arranged on cathode 12, preferably on cathode current collection layer 22, for preventing transpiration of water generated at cathode 12 from the cathode 12 side to the outside of unit cell 30. By providing second moisture retention layer 2, water generated at cathode 12 can efficiently be returned to anode 11 through electrolyte membrane 10 without transpiration of the same to the outside of unit cell 30, and hence effective use of water for reaction at anode 11 can further be promoted. Therefore, use of both of first moisture retention layer 1 and second moisture retention layer 2 is more advantageous in improvement of power generation characteristics.

Likewise first moisture retention layer 1, second moisture retention layer 2 is composed of a material which is gas-permeable so as to allow an oxidizing agent (such as air) from the outside of the fuel cell to permeate and insoluble in water and has a moisture retention property (a property not to allow transpiration of water) and preferably further has water repellency. Specific examples of second moisture retention layer 2 are also similar to those of first moisture retention layer 1.

Second moisture retention layer 2 desirably has such gas permeability as allowing an oxidizing agent (such as air) from the outside of the fuel cell to permeate and a moisture retention property (a property not allowing transpiration of water), and therefore, second moisture retention layer 2 has a porosity preferably not lower than 30% and not higher than 90% and more preferably not lower than 50% and not higher than 80%. When a porosity of second moisture retention layer 2 exceeds 90%, it becomes difficult to retain water generated at cathode 12 within unit cell 30, and there may be a case that high power generation characteristics cannot be exhibited in a stable manner. On the other hand, when a porosity of second moisture retention layer 2 is lower than 30%, diffusion of the oxidizing agent (such as air) from the outside of the fuel cell is interfered and power generation characteristics at cathode 12 tend to lower.

Though a thickness of second moisture retention layer 2 is not particularly restricted, in order to sufficiently express the function above, the thickness is preferably not smaller than 20 μm and more preferably not smaller than 50 μm. In addition, from a point of view of a smaller thickness of a fuel cell, second moisture retention layer 2 has a thickness preferably not greater than 500 μm and more preferably not greater than 300 μm.

[Electrolyte Membrane]

Electrolyte membrane 10 forming membrane electrode assembly 20 has a function to conduct protons from anode 11 to cathode 12 and a function to maintain electrical insulation between anode 11 and cathode 12 and preventing short-circuiting. A material for the electrolyte membrane is not particularly limited so long as a material has proton conductivity and electrical insulation, and a polymer film, an inorganic film, or a composite film can be employed. Examples of the polymer film include Nafion (trademark, manufactured by Du Pont), Aciplex (trademark, manufactured by Asahi Kasei Corporation), Flemion (trademark, manufactured by Asahi Glass Co., Ltd.), and the like, which are perfluorosulfonic-acid-based electrolyte membranes. In addition, a hydrocarbon-based electrolyte membrane or the like of a styrene-based graft polymer, a trifluorostyrene derivative copolymer, sulfonated polyarylene ether, sulfonated polyether ether ketone, sulfonated polyimide, sulfonated polybenzimidazole, phosphonated polybenzimidazole, sulfonated polyphosphazene, and the like can also be employed.

Examples of the inorganic film include a film composed of phosphate glass, cesium hydrogen sulfate, polytungstophosphoric acid, ammonium polyphosphate, and the like. Examples of the composite film include a composite film and the like of an inorganic substance such as tungstic acid, cesium hydrogen sulfate, and polytungstophosphoric acid and an organic substance such as polyimide, polyether ether ketone, and perfluorosulfonic acid.

Electrolyte membrane 10 has a thickness, for example, from 1 to 200 μm. In addition, electrolyte membrane 10 has an EW value (a dry weight per 1 mol of a proton functional group) preferably approximately from 800 to 1100. As the EW value is smaller, resistance of the electrolyte membrane accompanying proton migration is lower and high output can be obtained.

[Anode and Cathode]

Anode 11 stacked on one surface of electrolyte membrane 10 and cathode 12 stacked on the other surface thereof are each provided with a catalyst layer formed from a porous layer containing at least a catalyst and an electrolyte. At anode 11, a catalyst (an anode catalyst) catalyzes reaction for generating protons and electrons from fuel, and an electrolyte has a function to conduct generated protons to electrolyte membrane 10. At cathode 12, a catalyst catalyzes reaction for generating water from protons conducted through the electrolyte and an oxidizing agent (such as air).

The catalyst for anode 11 and cathode 12 may be carried on a surface of such an electrical conductor as carbon or titanium, and among others, it is preferably carried on a surface of such an electrical conductor as carbon or titanium having a hydrophilic functional group such as a hydroxyl group or a carboxyl group. Thus, a moisture retention property of anode 11 and cathode 12 can be improved.

The electrolyte for anode 11 and cathode 12 is preferably composed of a material smaller in EW value than electrolyte membrane 10, and specifically, it is preferably composed of an electrolyte material which is similar in nature to a material for electrolyte membrane 10 but has an EW value from 400 to 800. By employing such an electrolyte material as well, a moisture retention property of anode 11 and cathode 12 can be improved.

As the moisture retention property of anode 11 and cathode 12 improves, resistance of electrolyte membrane 10 accompanying proton migration or potential distribution at anode 11 and cathode 12 can be improved. In addition, since an electrolyte low in EW value is also high in fuel permeability at the same time, vaporized fuel can uniformly be supplied to a catalyst layer of anode 11 by employing an electrolyte low in EW value.

Anode 11 and cathode 12 may include an anode conductive porous layer (an anode gas diffusion layer) and a cathode conductive porous layer (a cathode gas diffusion layer) formed on the catalyst layers, respectively. These conductive porous layers have a function to diffuse a gas (vaporized fuel or an oxidizing agent) supplied to anode 11, cathode 12 in a plane and a function to supply and receive electrons to and from the catalyst layers. For the anode conductive porous layer and the cathode conductive porous layer, a porous material composed of: a carbon material; a conductive polymer; a precious metal such as Au, Pt, or Pd; a transition metal such as Ti, Ta, W, Nb, Ni, Al, Cu, Ag, or Zn: a nitride, a carbide, or the like of these metals; and an alloy containing these metals represented by stainless steel is preferably employed, because specific resistance is low and lowering in voltage is suppressed. In a case that a metal poor in corrosion resistance in an acidic atmosphere such as Cu, Ag, or Zn is employed, surface treatment (formation of a coating film) may be performed by using a noble metal having corrosion resistance such as Au, Pt, or Pd, an electrical conductive polymer, an electrical conductive nitride, an electrical conductive carbide, an electrical conductive oxide, or the like. More specifically, for example, a foam metal, a metal web, and a sintered metal composed of a precious metal, a transition metal, or an alloy above; carbon paper, a carbon cloth, and an epoxy resin film containing carbon particles; and the like can suitably be employed for the anode conductive porous layer and the cathode conductive porous layer.

[Anode Current Collection Layer and Cathode Current Collection Layer]

Anode current collection layer 21 and cathode current collection layer 22 are stacked on anode 11 and cathode 12, respectively, and constitute unit cell 30 together with membrane electrode assembly 20. Anode current collection layer 21 and cathode current collection layer 22 have a function to collect electrons at anode 11, cathode 12, respectively, and a function to provide electrical interconnections. A metal is preferably employed for a material for a current collection layer, because specific resistance is low and lowering in voltage is suppressed even when a current is extracted in an in-plane direction, and among others, a metal having electron conductivity and corrosion resistance in an acidic atmosphere is more preferred. Such a metal is exemplified by: a precious metal such as Au, Pt, or Pd; a transition metal such as Ti, Ta, W, Nb, Ni, Al, Cu, Ag, or Zn; a nitride, a carbide, or the like of these metals; an alloy containing these metals represented by stainless steel; and the like. In a case that a metal poor in corrosion resistance in an acidic atmosphere such as Cu, Ag, or Zn is employed, surface treatment (formation of a coating film) may be performed by using a noble metal having corrosion resistance such as Au, Pt, or Pd, an electrical conductive polymer, an electrical conductive nitride, an electrical conductive carbide, an electrical conductive oxide, or the like. It is noted that, when the anode conductive porous layer and the cathode conductive porous layer are composed, for example, of a metal or the like and electrical conductivity is relatively high, it is not necessary to provide an anode current collection layer and a cathode current collection layer.

More specifically, anode current collection layer 21 can be a flat plate including a plurality of through holes (openings) passing through in a direction of thickness, for guiding vaporized fuel to anode 11 and having a mesh shape or a punched metal shape formed of the metal material above. This through hole also functions as a path for guiding a by-product gas (a CO₂ gas or the like) generated in the catalyst layer of anode 11 toward vaporized fuel accommodation portion 3a. Similarly, cathode current collection layer 22 can be a flat plate including a plurality of through holes (openings) passing through in a direction of thickness, for supplying an oxidizing agent (such as air outside the fuel cell) to the catalyst layer of cathode 12 and having a mesh shape or a punched metal shape formed of the metal material above.

[Vaporized Fuel Plate]

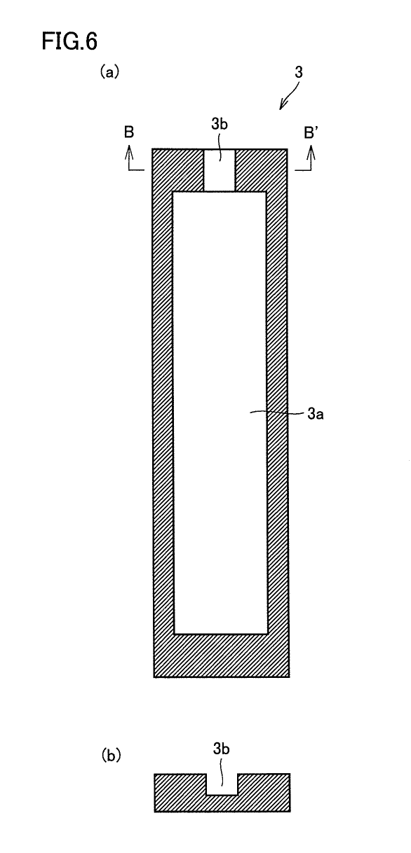

FIG. 6(a) is a schematic top view showing vaporized fuel plate 3 included in fuel cell 100 shown in FIG. 1, and FIG. 6(b) is a schematic cross-sectional view along the line B-B′ shown in FIG. 6(a). Vaporized fuel plate 3 is a member for forming a space for accommodating vaporized fuel (that is, vaporized fuel accommodation portion 3a) between first moisture retention layer 1 and gas-liquid separation layer 7. Vaporized fuel plate 3 is arranged on first moisture retention layer 1 so as to be in contact with first moisture retention layer 1. Vaporized fuel plate 3 has vaporized fuel accommodation portion 3a which is a through port passing through in a direction of thickness and communication path 3b communicating vaporized fuel accommodation portion 3a and the outside of vaporized fuel plate 3 with each other. Communication path 3b is a path for exhausting a by-product gas (a CO₂ gas or the like) generated at anode 11 to the outside of the fuel cell.

In vaporized fuel plate 3 shown in FIG. 6, communication path 3b is made by a groove (a recess) provided in a peripheral portion of vaporized fuel plate 3 and extending from vaporized fuel accommodation portion 3a to an end surface of the peripheral portion. This peripheral portion is a peripheral portion most distant from fuel storage portion 70, among four peripheral portions (see FIG. 1). It is noted that a position of the communication path is not limited to this position, and it may be formed in another peripheral portion.

By providing vaporized fuel accommodation portion 3a over liquid fuel supply portion 60 with gas-liquid separation layer 7 being interposed, uniformity of a concentration of vaporized fuel supplied to anode 11 in a plane of the anode and optimization of an amount of vaporized fuel are promoted. Here, in the present embodiment, since first moisture retention layer 1 is interposed between anode current collection layer 21 and vaporized fuel accommodation portion 3a, no transpiration of moisture in anode 11 to vaporized fuel accommodation portion 3a takes place even though such a space as vaporized fuel accommodation portion 3a is provided over anode 11.

It is advantageous to provide vaporized fuel accommodation portion 3a also in the following points.

(i) An air layer present within vaporized fuel accommodation portion 3a can achieve heat insulation between a power generation portion (a membrane electrode assembly) of the unit cell and liquid fuel accommodation portion 60. Thus, crossover due to excessive increase in temperature in liquid fuel accommodation portion 60 can be suppressed, which contributes to suppression of runaway of an internal temperature of a cell and increase in an internal pressure.

(ii) A by-product gas such as a CO₂ gas generated at anode 11 reaches the inside of vaporized fuel accommodation portion 3a with heat generated through power generation, and in succession, it is exhausted to the outside of the fuel cell through communication path 3b (further through first open hole 63 in the embodiment shown in FIG. 1). Since an amount of heat accumulated in the fuel cell can thus significantly be reduced, temperature increase in the fuel cell as a whole including liquid fuel accommodation portion 60 can be suppressed, which again contributes to suppression of runaway of an internal temperature of a cell and increase in an internal pressure. In particular, since communication path 3b (an exhaust port for a by-product gas) is provided in vaporized fuel plate 3, conduction of heat to liquid fuel accommodation portion 60 is less likely and hence excessive temperature increase in liquid fuel accommodation portion 60 and crossover and temperature runaway accompanying therewith are further less likely.

(iii) Since a by-product gas can satisfactorily be exhausted through communication path 3b, interference of fuel supply due to poor exhaust of the by-product gas can be suppressed and fuel can satisfactorily be supplied to anode 11. Thus, stable power generation characteristics can be obtained. In addition, since a by-product gas can satisfactorily be exhausted through communication path 3b, entry of the by-product gas into liquid fuel accommodation portion 60 can be suppressed. Thus, since a sufficient amount of vaporized fuel can be supplied to anode 11 in a stable manner, output stability of the fuel cell can be improved.

Vaporized fuel plate 3 can have a thickness, for example, approximately from 100 to 1000 μm, and even though the thickness is made smaller to approximately 100 to 300 μm, an effect as described above can sufficiently be obtained.

A through port of vaporized fuel plate 3 (vaporized fuel accommodation portion 3a) preferably has a ratio of opening to an area of vaporized fuel plate 3 as high as possible as shown in FIG. 6 from a point of view of heat insulation between the power generation portion and liquid fuel accommodation portion 60, and therefore, vaporized fuel plate 3 preferably has a frame shape (a shape of a square) having a through port as large as possible.

An opening ratio of a through port, that is, a ratio of an opening area of a through port to an area of vaporized fuel plate 3 (as will be described later, vaporized fuel plate 3 may have two or more through ports, and in that case, a total of opening areas thereof) is preferably not lower than 50% and more preferably not lower than 60%. A higher opening ratio of a through port is advantageous also in enhancing a function of vaporized fuel accommodation portion 3a to make a concentration of fuel supplied to anode 11 uniform, and it is also advantageous in ensuring sufficient fuel supply to anode 11. It is noted that an opening ratio of a through port is normally not higher than 90%.

Communication path 3b is not limited to a groove (a recess) provided in a peripheral portion of vaporized fuel plate 3 and it may be a through hole passing through in a direction of thickness. From a point of view of strength, however, communication path 3b is preferably formed from a groove (a recess). When communication path 3b is formed from a groove (a recess), communication path 3b has a depth preferably not smaller than 50 μm. By setting a depth to 50 μm or greater, clogging of communication path 3b by a thermocompression sheet can be prevented even when an adjacent member and vaporized fuel plate 3 are bonded to each other through hot pressing (thermocompression) with the use of a thermocompression sheet. In addition, from a point of view of strength of vaporized fuel plate 3, a depth of communication path 3b is preferably up to approximately 75% of a thickness of vaporized fuel plate 3.

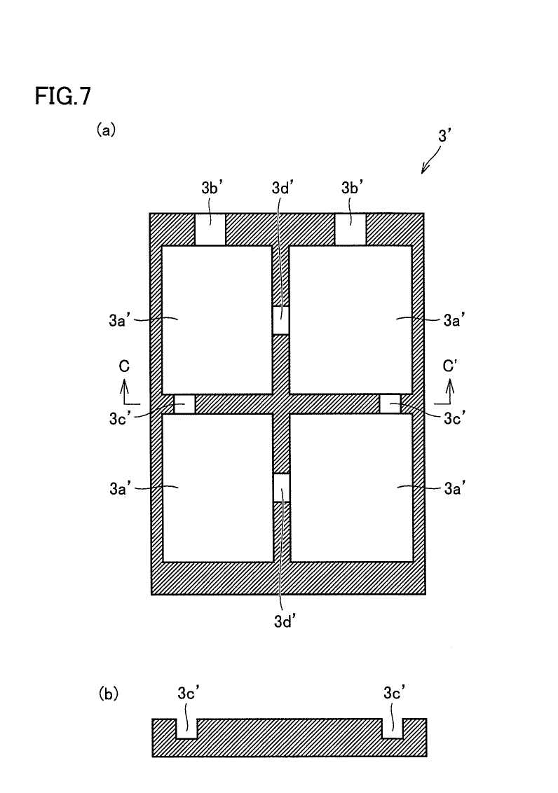

FIG. 7(a) is a schematic top view showing another example of a vaporized fuel plate, and FIG. 7(b) is a schematic cross-sectional view along the line C-C′ shown in FIG. 7(a). As shown in FIG. 7, the vaporized fuel plate may have two or more through ports. In the example in FIG. 7, a vaporized fuel plate 3′ has four through ports 3a′ in total, arranged in two vertical rows and two horizontal columns. This can also be called a plate obtained by providing a beam in each of a vertical direction and a horizontal direction of a large through port for division into four. Such a vaporized fuel plate having a plurality of through ports (provided with beams) has improved rigidity in an in-plane direction of the vaporized fuel plate, and hence it is advantageous in that a fuel cell excellent in strength against impact or the like is obtained. In addition, as compared with a structure not having a beam as shown in FIG. 6, it is also advantageous in that clogging of a through port due to expansion or the like attributed to heat or the like from members arranged above and below the vaporized fuel plate is further less likely.

When the vaporized fuel plate has two or more through ports, a communication path provided in a vaporized fuel plate peripheral portion may be provided for each through port, and the number thereof may be as large as the number of through ports, or communication paths smaller or greater in number than through ports can also be provided. In the example in FIG. 7, two communication paths 3b′ are provided for four through ports 3a′ only in a peripheral portion most distant from fuel storage portion 70. Thus, a communication path does not have to be provided for each through port, however, in that case, as shown in FIG. 7, through ports not provided with communication path 3b′ (two lower through ports 3a′ in FIG. 7(a)) are connected spatially to through ports provided with communication path 3b′ (two upper through ports 3a′ in FIG. 7(a)) through connection paths 3c′. Connection path 3c′ can be a groove (a recess) provided in a beam between through ports, similarly to communication path 3b′ (see FIG. 7(b)). By providing connection path 3c′, a by-product gas which has entered a through port not provided with communication path 3b′ can be exhausted to the outside through communication path 3b′.

In order to improve efficiency in exhausting a by-product gas which has reached a through port in the vaporized fuel plate (a vaporized fuel accommodation portion) to the outside or in order to enhance a function of the vaporized fuel plate to make a concentration of fuel supplied to anode 11 uniform, preferably, connection path(s) 3d′ spatially connecting through ports provided with communication path 3b′ to each other and/or through ports not provided with communication path 3b′ to each other is (are) also provided (see FIG. 7(a)).

A shape of a plurality of through ports (a width, a length, and the like), the number of arranged through ports, or the like (in other words, the number of beams provided vertically and horizontally, an arrangement interval, or the like) is preferably determined in consideration of a position of a recess or the number of recesses forming liquid fuel accommodation portion 60 in box housing 40, an arrangement interval thereof in a case that a plurality of recesses are provided, and the like.

Though a communication path may be provided in any peripheral portion of four peripheral portions, in a case that a gradient of an amount of fuel supply is created in a plane of anode 11 in such a case that fuel storage portion 70 is arranged lateral to unit cell 30 as in the example shown in FIG. 1, from a point of view of higher efficiency in use of fuel, at least one of communication paths is preferably provided in a peripheral portion most distant from fuel storage portion 70, and more preferably, all communication paths are provided in a peripheral portion most distant from fuel storage portion 70. Namely, by providing a communication path at such a position, an amount of fuel exhausted from the communication path can be minimized. In addition, when a fuel cell has a stack structure including a plurality of unit cells arranged on the same plane in a line, a communication path is preferably provided in a peripheral portion not facing an adjacent unit cell so as not to interfere air supply to the adjacent unit cell due to exhaust of a by-product gas. For example, when unit cells are stacked by arranging a plurality of unit cells in a line, fuel storage portion 70 can be arranged along any one of two peripheral portions not facing an adjacent unit cell in the stack structure and all communication paths can be provided in the other peripheral portion (that is, a peripheral portion most distant from fuel storage portion 70). Thus, interference of air supply to unit cell 30 can be prevented and an amount of fuel exhausted through a communication path can be minimized.

A ratio S₁/S₀ between a cross-sectional area of a communication path (when two or more communication paths are provided, a total of these cross-sectional areas) S₁ and a total area S₀ of side surfaces of a vaporized fuel plate should be higher than 0 in order to exhaust a by-product gas and heat accompanying the same, and it is preferably not lower than 0.002. In addition, the ratio is preferably lower than 0.3, more preferably lower than 0.1, and further preferably lower than 0.05. When the ratio is 0.3 or higher, leakage of fuel or introduction of air is likely and stability in power generation may lower.

When one, or two or more communication path(s) is (are) provided only in any one peripheral portion of four peripheral portions of the vaporized fuel plate in such a case that all communication paths are provided in a peripheral portion most distant from fuel storage portion 70, a ratio S₁/S₂ between a cross-sectional area of a communication path (when two or more communication paths are provided, a total of these cross-sectional areas) S₁ and a cross-sectional area S₂ of a side surface in a peripheral portion where the communication path is provided is preferably not lower than 0.008 for the reason the same as above.

A material for a vaporized fuel plate can be plastic, a metal, a non-porous carbon material, and the like. Examples of plastic include polyphenylene sulfide (PPS), polyimide (PI), polymethyl methacrylate (PMMA), acrylonitrile-butadiene-styrene (ABS), polyvinyl chloride, polyethylene (PE), polyethylene terephthalate (PET), polyether ether ketone (PEEK), polytetrafluoroethylene (PTFE), polyvinylidene fluoride (PVDF), and the like. For a metal, for example, other than titanium, aluminum, and the like, an alloy such as stainless steel and a magnesium alloy can be employed. From a point of view of further improvement in heat insulation between the power generation portion and liquid fuel accommodation portion 60, a material low in thermal conductivity is preferably employed for the vaporized fuel plate, however, with regard to heat insulation by the vaporized fuel plate, contribution by an air layer formed within a through port is greater than contribution by thermal conductivity of a material. Therefore, in terms of heat insulation, it is important to consider a volume of an air layer (an opening ratio of a through port and a thickness), rather than a material for the vaporized fuel plate.

Among the above, the vaporized fuel plate is preferably composed of a material high in rigidity such as a metal, polyphenylene sulfide (PPS), or polyimide (PI). By employing a vaporized fuel plate high in rigidity, the vaporized fuel plate and a member adjacent thereto can be bonded to each other by hot pressing (thermocompression), and hence variation in thickness or power generation characteristics of a fuel cell can be lessened. In addition, clogging of a communication path can effectively be prevented during hot pressing.

[Gas-Liquid Separation Layer]

Gas-liquid separation layer 7 interposed between vaporized fuel accommodation portion 3a and liquid fuel accommodation portion 60 and arranged to cover an opening of liquid fuel accommodation portion 60 (a surface opening to the anode 11 side) (that is, to cover a recess forming liquid fuel accommodation portion 60) has a two-layered structure preferably of first layer 5 and second layer 4 having gas-liquid separation capability and stacked on the surface of first layer 5 on the unit cell 30 side, as shown in FIG. 1.

(1) First Layer

First layer 5 is a layer having a bubble point not lower than 30 kPa with methanol serving as a measurement medium. By arranging such first layer 5 so as to cover an opening of liquid fuel accommodation portion 60, liquid fuel is retained in pores in first layer 5 owing to capillarity and hence entry of a by-product gas generated at anode 11 into liquid fuel accommodation portion 60 can effectively be prevented.

In addition, it is advantageous to provide first layer 5 also in the following points.

(i) The fact that a by-product gas generated at anode 11 can be prevented from entering liquid fuel accommodation portion 60 means that a route for exhaust of the by-product gas to the outside of the fuel cell is limited to an exhaust route through communication path 3b of vaporized fuel plate 3. Therefore, exhaust of a by-product gas through communication path 3b and exhaust of heat accompanying therewith can be promoted and conduction of heat to liquid fuel accommodation portion 60 can more effectively be suppressed. Thus, excessive temperature increase in the fuel cell as a whole including liquid fuel accommodation portion 60 and crossover and temperature runaway accompanying therewith can more effectively be suppressed.

(ii) Entry of a by-product gas into liquid fuel accommodation portion 60 lowers an amount of supply of vaporized fuel to anode 11, interferes with stable supply of vaporized fuel, and lowers output stability of the fuel cell. By providing first layer 5, entry of a by-product gas into liquid fuel accommodation portion 60 can be prevented, so that a sufficient amount of vaporized fuel can be supplied to anode 11 in a stable manner and output stability of the fuel cell can be improved. In addition, since separation at an interface between constituent members due to entry of a by-product gas and resultant increase in an internal pressure in liquid fuel accommodation portion 60 or breakage of a constituent member can more effectively be suppressed, reliability of the fuel cell can further be improved.

(iii) Since liquid fuel can be transported from fuel storage portion 70 into liquid fuel accommodation portion 60 by making use of capillarity of first layer 5, passive supply of liquid fuel can be achieved. Thus, need for such auxiliary equipment as a pump for sending liquid fuel can be obviated. In addition, since fuel can be supplied owing to capillarity, direction-dependency of fuel supply can be eliminated (that is, electric power can be generated regardless of an orientation of a fuel cell during use).

(iv) When a material low in thermal conductivity such as a polymer material is employed for first layer 5, liquid fuel retained in first layer 5 is less likely to be affected by sudden temperature increase in the power generation portion and temperature increase thereof becomes gradual. Consequently, since liquid fuel retained in first layer 5 can be maintained at a relatively low temperature in a stable manner, an amount of supply of vaporized fuel supplied to anode 11 can be stabilized, which contributes to improvement in reliability of the fuel cell.

(v) Since liquid fuel uniformly spreads in a plane of first layer 5 and retained therein, vaporized fuel can uniformly be supplied to an anode surface and locally excessive supply of fuel to the power generation portion or shortage in fuel therein does not occur, and thus deterioration of a material such as a catalyst is suppressed, which contributes to improvement in output and improvement in reliability of the fuel cell.

(vi) By increasing a pressure in liquid fuel accommodation portion 60 with such a method as delivering liquid fuel accommodated in fuel storage portion 70 to liquid fuel accommodation portion 60 by using delivery means such as a pump, a by-product gas generated at anode 11 can be prevented from entering liquid fuel accommodation portion 60 to some extent, however, it is overcome by an effect of prevention of entry by first layer 5. Therefore, it is not necessary to increase an internal pressure in liquid fuel accommodation portion 60. Thus, risk of liquid leakage due to increase in internal pressure can be avoided and reliability of the fuel cell can be improved.

Here, a bubble point means a minimum pressure at which generation of bubbles is observed at a surface of a layer (a membrane) when an air pressure is applied from a back side of the layer (the membrane) wetted with a liquid medium. As the bubble point is higher, gas permeability is lower. A bubble point AP is defined by an equation (3) below:

ΔP[Pa]=4γ cos θ/d (3)

(where γ represents surface tension [N/m] of a measurement medium,74 represents a contact angle between a source material for a layer (a membrane) and a measurement medium, and d represents a maximum pore diameter in a layer (a membrane)). In the present invention, a bubble point is measured in conformity with JIS K 3832, with methanol serving as a measurement medium.

From a point of view of effective prevention of entry of a by-product gas into liquid fuel accommodation portion 60, a bubble point of first layer 5 is preferably not lower than 50 kPa and more preferably not lower than 100 kPa. The bubble point of first layer 5 can be controlled by adjusting a pore diameter in a material used for first layer 5 or a contact angle, as understood from (3) above.

In order to achieve a bubble point not lower than 30 kPa, a maximum pore diameter of pores in first layer 5 is preferably not greater than 1 μm and more preferably not greater than 0.7 μm. Though the maximum pore diameter is obtained by measuring the bubble point above, as a method other than that, it can be measured with a mercury intrusion method. It is noted that, since only pore distribution from 0.005 μm to 500 μm can be measured with the mercury intrusion method, it is effective measurement means in a case that a pore out of this range is not present or such a pore is ignorable.

For first layer 5, for example, a porous layer composed of a polymer material, a metal material, an inorganic material, or the like, and a polymer membrane can be exemplified, and specific examples are as follows.

1) A porous layer composed of a material as follows: a fluorine-based resin such as polyvinylidene fluoride (PVDF) and polytetrafluoroethylene (PTFE); an acrylic resin; an ABS resin; a polyolefin-based resin such as polyethylene and polypropylene; a polyester-based resin such as polyethylene terephthalate; a cellulose-based resin such as cellulose acetate, nitrocellulose, and ion-exchange cellulose; nylon; a polycarbonate-based resin; a chlorine-based resin such as polyvinyl chloride; polyether ether ketone;

polyether sulfone; glass; ceramics; and a metal material such as stainless steel, titanium, tungsten, nickel, aluminum, and steel. The porous layer can be a foam, a sintered object, unwoven fabric, fibers (such as glass fibers), and the like composed of these materials.

2) A polymer membrane composed of a material as follows: a material which can be used as an electrolyte membrane material such as a perfluorosulfonic-acid-based polymer; and a hydrocarbon-based polymer such as a styrene-based graft polymer, a trifluorostyrene derivative copolymer, sulfonated polyarylene ether, sulfonated polyether ether ketone, sulfonated polyimide, sulfonated polybenzimidazole, phosphonated polybenzimidazole, and sulfonated polyphosphazene. These polymer membranes have pores of a nano order as gaps among three-dimensionally entangled polymers.

When a polymer material is employed as a material forming first layer 5, a bubble point of first layer 5 can also be raised by performing hydrophilization treatment with such a method as introducing a hydrophilic functional group and enhancing wettability to water (therefore, fuel such as methanol or a methanol aqueous solution) on a surface of a pore.

Though a thickness of first layer 5 is not particularly restricted, from a point of view of a smaller thickness of a fuel cell, the thickness is preferably from 20 to 500 μm and more preferably from 50 to 200 μm. Though first layer 5 does not have to be provided, in order to obtain the effect above, gas-liquid separation layer 7 preferably includes first layer 5.

(2) Second Layer

Second layer 4 stacked on the surface of first layer 5 on the unit cell 30 side is a porous layer having vaporized fuel permeability (a property allowing permeation of a vaporized component of liquid fuel) and hydrophobicity not allowing permeation of liquid fuel, and it is a layer having gas-liquid separation capability allowing vaporized supply of fuel to anode 11. Second layer 4 also has a function to control (restrict) an amount or a concentration of vaporized fuel supplied to anode 11 to an appropriate amount and making the same uniform. By providing second layer 4, crossover of the fuel can effectively be suppressed, temperature variation is less likely in the power generation portion, and a stable power generation state can be maintained.

Though second layer 4 is not particularly restricted so long as it has gas-liquid separation capability for fuel to be used, for example, second layer 4 is exemplified by a porous film or a porous sheet composed of a fluorine-based resin such as polytetrafluoroethylene (PTFE) and polyvinylidene fluoride, a silicone resin subjected to water-repellent treatment, or the like. Specifically, TEMISH®, “NTF2026A-N06” or “NTF2122A-S06”, manufactured by Nitto Denko Corporation, which is a porous film composed of polytetrafluoroethylene, can be exemplified.

Since second layer 4 has vaporized fuel permeability, it is lower in bubble point than first layer 5. A bubble point of second layer 4 in accordance with the measurement method above is preferably not higher than 10 kPa, and a greater contact angle of methanol with respect to second layer 4 is preferred. The contact angle is preferably not smaller than 45 degrees and more preferably not smaller than approximately 90 degrees. In addition, from a point of view of providing vaporized fuel permeability and liquid fuel impermeability, a maximum pore diameter of pores in second layer 4 is preferably from 0.1 to 10 μm and more preferably from 0.5 to 5 μm. As in the case of first layer 5, a maximum pore diameter of pores in second layer 4 can be found by measuring a bubble point with the use of methanol or the like.

Though a thickness of second layer 4 is not particularly restricted, in order to sufficiently express the function above, the thickness is preferably not smaller than 20 μm and more preferably not smaller than 50 μm. In addition, from a point of view of a smaller thickness of a fuel cell, second layer 4 has a thickness preferably not greater than 500 μm and more preferably not greater than 300 μm.

(3) Third Layer

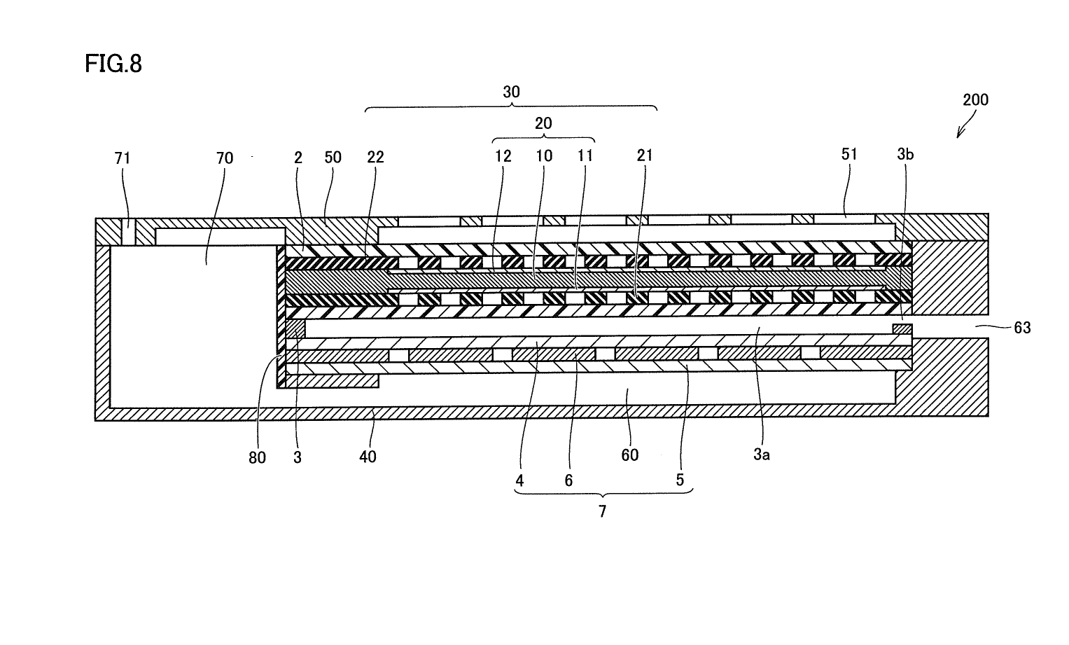

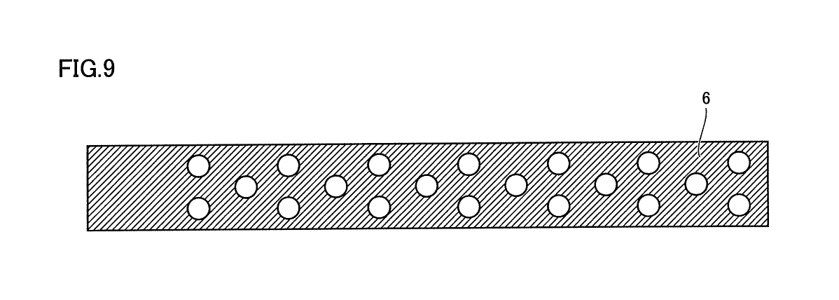

Gas-liquid separation layer 7 may have a third layer interposed between first layer 5 and second layer 4. FIG. 8 shows one example of a fuel cell in which gas-liquid separation layer 7 includes a third layer 6. A fuel cell 200 shown in FIG. 8 is the same as fuel cell 100 shown in FIG. 1 except that gas-liquid separation layer 7 further includes third layer 6. In addition, FIG. 9 is a schematic top view showing third layer 6 included in fuel cell 200.

Third layer 6 is a layer arranged between first layer 5 and second layer 4 and having a through hole passing through in a direction of thickness through which liquid fuel can permeate, it plays a role for two-dimensionally bonding at least first layer 5 and second layer 4 with each other with good adhesion, and it preferably has a function to adjust (restrict) an amount of permeation of liquid fuel toward second layer 4. For third layer 6, for example, a non-porous sheet (film) having a through hole passing through in a direction of thickness as shown in FIGS. 8 and 9 can be employed, and a material therefor can preferably be exemplified by a thermosetting resin. By thermocompression of a stack structure constituted of the first layer/the third layer/the second layer with the use of such a material, the layers can two-dimensionally be bonded to one another with good adhesion. A fuel cell in which gas-liquid separation layer 7 has a non-porous sheet as third layer 6, having a through hole passing through in a direction of thickness and allowing two-dimensional bond, is advantageous in the following points.

(i) Since first layer 5 and second layer 4 can be bonded to each other with good adhesion with third layer 6 being interposed, a by-product gas does not stay between first layer 5 and second layer 4, variation in an amount of permeation of vaporized fuel in a plane of second layer 4 can be suppressed, fuel can thus uniformly be supplied to anode 11, and output can be improved. In addition, when third layer 6 is composed of a resin, such an effect that heat is less likely to conduct to liquid fuel in spite of sudden temperature increase in the power generation portion is achieved. Consequently, since temperature increase in liquid fuel becomes gradual and liquid fuel can be maintained at a relatively low temperature in a stable manner, an amount of supply of vaporized fuel supplied to anode 11 can be stabilized, which contributes to improvement in reliability of the fuel cell.

(ii) Depending on the number of through holes formed in third layer 6 or an open hole diameter thereof, an amount of permeation of liquid fuel toward second layer 4 and an amount of supply of vaporized fuel to anode 11 can be adjusted (restricted) to an appropriate amount. Thus, prevention or suppression of crossover of fuel and stabilization of fuel supply can be achieved. Though the number of through holes is not particularly restricted, a plurality of through holes are preferably present. From a point of view of making an amount of permeation of vaporized fuel in a plane of second layer 4 uniform, these through holes are preferably uniformly distributed in a region of third layer 6 directly above liquid fuel accommodation portion 60. An open hole diameter (a diameter) of a through hole can be, for example, approximately from 0.1 to 5 mm.

(iii) Since third layer 6 can allow satisfactory two-dimensional bond between first layer 5 and second layer 4, fastening of a fuel cell with the use of such a fastening member as a bolt and a nut or a screw is not necessary, and a fuel cell can be smaller in thickness.

(iv) Since gas-liquid separation layer 7 can readily be fabricated through hot pressing (thermocompression), a process for manufacturing a fuel cell can be simplified and manufacturing efficiency can be improved.

In addition to a thermosetting resin sheet described above, third layer 6 may be formed, for example, of the following.

1) A porous layer formed of a resin or a resin composition having adhesiveness, such as a porous layer formed of such an adhesive as a hotmelt-type adhesive or a hardening adhesive. When such an adhesive is employed, third layer 6 is an adhesive layer, that is, a porous layer formed of such an adhesive or a hardened product thereof. Even when such third layer 6 is employed, an effect the same as in (i) to (iii) above can be obtained. An amount of permeation of liquid fuel toward second layer 4 is adjusted (restricted) by pores in the porous layer.

2) A layer or layers including a preferably non-porous metal plate having a through hole passing through in a direction of thickness. In this case, an adhesive layer is formed on each of opposing surfaces of the metal plate in order to ensure good adhesiveness with first layer 5 and second layer 4, and therefore third layer 6 has a three-layered structure of the adhesive layer/the metal plate/the adhesive layer. The adhesive layer is a porous layer formed of an adhesive or a hardened product thereof. An adhesive can be a hotmelt-type adhesive, a hardening adhesive, or the like. Even when such a third layer is employed, an effect the same as in (i) to (iii) above can be obtained. An amount of permeation of liquid fuel toward second layer 4 can be adjusted (controlled) by the number of through holes formed in the metal plate or a diameter of open holes as in the case of a thermosetting resin sheet. The adhesive layer is preferably formed not to close a through hole. Though the number of through holes is not particularly restricted, a plurality of through holes are preferably present. From a point of view of making an amount of permeation of vaporized fuel in a plane of second layer 4 uniform, these through holes are preferably uniformly distributed in a region of the metal plate directly above liquid fuel accommodation portion 60. An open hole diameter (a diameter) of a through hole can be, for example, approximately from 0.1 to 5 mm.

[Liquid Fuel Accommodation Portion]

Liquid fuel accommodation portion 60 is a site for allowing liquid fuel transferred from fuel storage portion 70 to flow, and it is preferably arranged directly under anode 11. In fuel cell 100 shown in FIG. 1, liquid fuel accommodation portion 60 is formed from a space having a length equal to or longer than a length from an end portion of anode 11 on the fuel storage portion 70 side to an end portion opposite thereto and having a width equal to or greater than a width of anode 11. A height (a depth) of liquid fuel accommodation portion 60 is not particularly restricted.

In fuel cell 100 in the present embodiment, liquid fuel accommodation portion 60 is formed from gas-liquid separation layer 7 and box housing 40 arranged under unit cell 30 to be in contact with gas-liquid separation layer 7 and having a recess forming an internal space of liquid fuel accommodation portion 60. It is noted that, though box housing 40 shown in FIG. 1 has a site forming a bottom wall and sidewalls of fuel storage portion 70 integrally with a site forming liquid fuel accommodation portion 60, it is not limited as such and it may be a member different from a member forming liquid fuel accommodation portion 60 and a member forming fuel storage portion 70.

Box housing 40 can be fabricated by using a plastic material or a metal material and forming the material to an appropriate shape so as to have a recess forming at least an internal space of a fuel supply chamber 60. Examples of a plastic material include polyphenylene sulfide (PPS), polymethyl methacrylate (PMMA), acrylonitrile-butadiene-styrene (ABS), polyvinyl chloride, polyethylene (PE), polyethylene terephthalate (PET), polyether ether ketone (PEEK), polytetrafluoroethylene (PTFE), polyvinylidene fluoride (PVDF), and the like. For a metal material, for example, other than titanium, aluminum, and the like, an alloy material such as stainless steel and a magnesium alloy can be employed. Among these, polyphenylene sulfide (PPS) and polyethylene (PE) are preferably employed, because of high strength owing to increase in a molecular weight resulting from three-dimensional cross-linking, processing at low cost, and light weight.

Box housing 40 has first open hole 63 for exhausting a by-product gas exhausted through communication path 3b in an heat exhaust layer 1 and accompanying heat to the outside of fuel cell 100. First open hole 63 is a through hole provided in a sidewall of box housing 40. In order to suppress or prevent exhaust of fuel through first open hole 63, a porous layer containing a catalyst for combusting fuel may be formed in first open hole 63. Owing to communication path 3b and first open hole 63 provided in the vaporized fuel plate, even during operation of the fuel cell, pressure increase in liquid fuel accommodation portion 60 does not take place and liquid fuel accommodation portion 60 is maintained at an atmospheric pressure.

[Fuel Storage Portion]

Fuel storage portion 70 is preferably a site for storing liquid fuel, which is arranged lateral to unit cell 30 and liquid fuel accommodation portion 60. In fuel cell 100 in the present embodiment, fuel storage portion 70 is formed from lid housing 50 stacked on second moisture retention layer 2 and having a plurality of openings 51, box housing 40, and sealing layer 80.

It is noted that fuel storage portion 70 does not necessarily have to be formed from these lid housing 50 and box housing 40, and it may be formed, for example, from one member integrally including an upper wall (a ceiling wall), sidewalls, and a bottom wall of fuel storage portion 70.

Lid housing 50 functions as a protection plate forming the upper wall (the ceiling wall) of fuel storage portion 70 and preventing direct exposure of second moisture retention layer 2. In a portion of lid housing 50 directly above cathode 12, a plurality of openings 51 for allowing an oxidizing agent (such as air) to flow are formed (it is noted that the number of openings should only be one or more).

Lid housing 50 can be fabricated by using a plastic material or a metal material and forming the material to an appropriate shape. Examples of a plastic material include polyphenylene sulfide (PPS), polymethyl methacrylate (PIMMA), acrylonitrile-butadiene-styrene (ABS), polyvinyl chloride, polyethylene (PE), polyethylene terephthalate (PET), polyether ether ketone (PEEK), polytetrafluoroethylene (PTFE), polyvinylidene fluoride (PVDF), and the like. For a metal material, for example, other than titanium, aluminum, and the like, an alloy material such as stainless steel and a magnesium alloy can be employed. Among these, polyphenylene sulfide (PPS) and polyethylene (PE) are preferably employed, because of high strength owing to increase in a molecular weight resulting from three-dimensional cross-linking, processing at low cost, and light weight.

Fuel storage portion 70 preferably includes second open hole 71 communicating an internal space thereof and the outside of the fuel cell with each other. Thus, even when liquid fuel is transported to liquid fuel accommodation portion 60, the inside of fuel storage portion 70 is maintained at an atmospheric pressure and therefore the liquid fuel can smoothly be transported. In fuel cell 100 shown in FIG. 1, though second open hole 71 is a through hole passing through lid housing 50 in a direction of thickness, limitation thereto is not intended.

In order to prevent leakage of liquid fuel through second open hole 71, an open hole diameter of second open hole 71 is preferably sufficiently small (for example, a diameter approximately from 100 to 500 μm and preferably from 100 to 300 μm), or a gas-liquid separation membrane for preventing leakage of liquid fuel to the outside of the fuel cell (for example, a porous film composed of polytetrafluoroethylene, polyvinylidene fluoride, polyethylene, or the like) may be provided within second open hole 71.

(Variation)

The fuel cell according to the present invention is not limited to the embodiment and the variation described above, and for example, it includes also variations as follows.

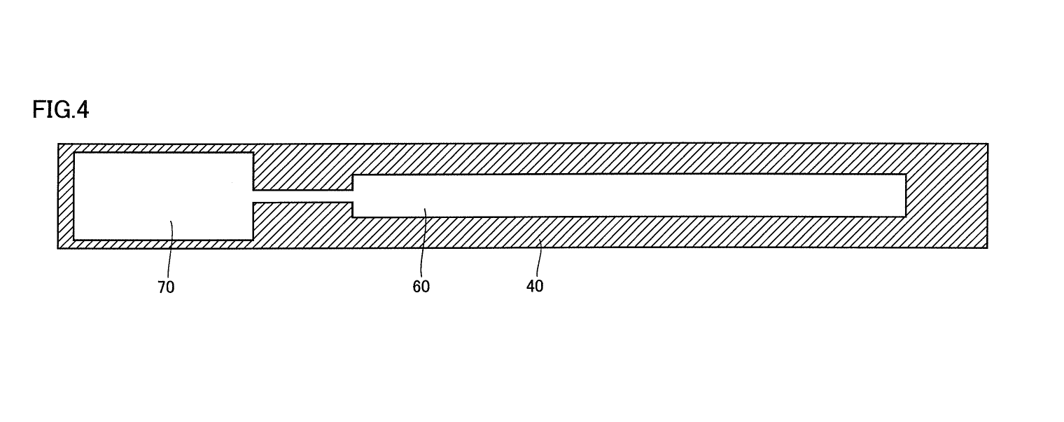

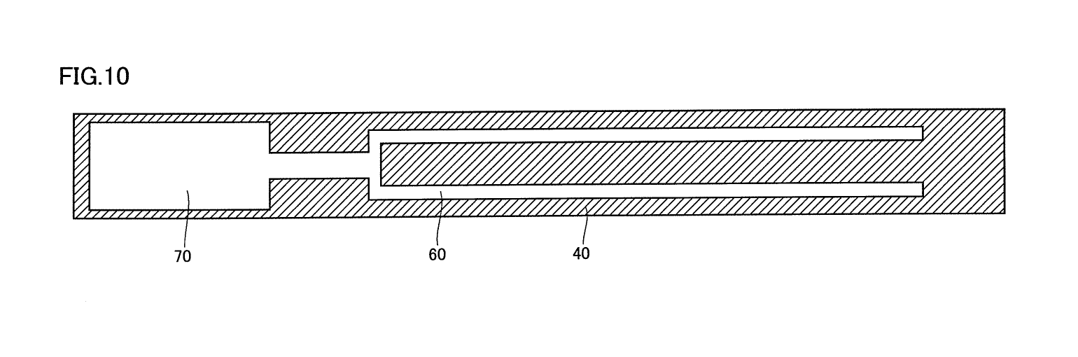

(1) A shape of a space in liquid fuel accommodation portion 60 is not limited to the shape shown in FIG. 4. Liquid fuel accommodation portion 60 may be formed from a plurality of branched flow paths, for example, as shown in FIG. 10. Alternatively, it can be formed from a plurality of linear flow paths, a serpentine flow path, or the like. FIG. 10 is a schematic cross-sectional view similar to FIG. 4, showing another example of liquid fuel accommodation portion 60.

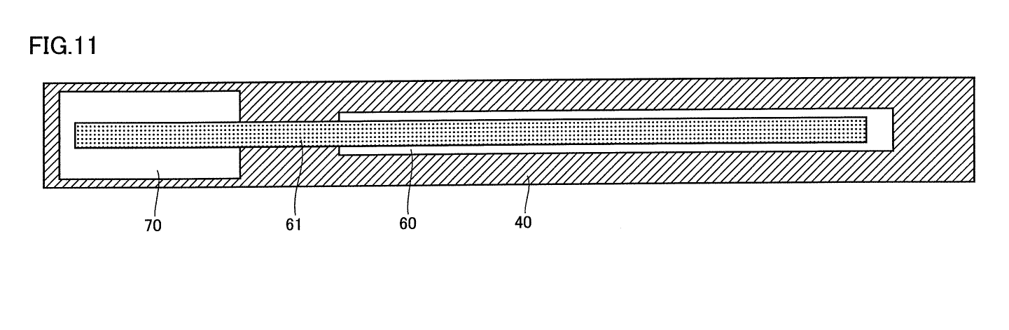

(2) FIG. 11 is a schematic cross-sectional view similar to FIG. 4, showing another example of liquid fuel accommodation portion 60. As shown in FIG. 11, liquid fuel accommodation portion 60 may include a fuel transportation member 61. Fuel transportation member 61 is a member at least a part of which is arranged within liquid fuel accommodation portion 60, for transporting liquid fuel from fuel storage portion 70 to liquid fuel accommodation portion 60 by making use of a capillary phenomenon, and it can play a role for helping transportation of liquid fuel by making use of capillarity of first layer 5.

Fuel transportation member 61 is composed of a material exhibiting a capillary action on liquid fuel. Materials exhibiting such a capillary action are exemplified by:

an acrylic resin; an ABS resin; a polyolefin-based resin such as polyethylene; a polyester-based resin such as polyethylene terephthalate; nylon; polyvinyl chloride; polyether ether ketone; a fluorine-based resin such as polyvinylidene fluoride and polytetrafluoroethylene; a porous body having irregular pores and composed of a polymer material (a plastic material) such as cellulose; and a porous body having irregular pores and composed of a metal material such as stainless steel, titanium, tungsten, nickel, aluminum, and steel. The porous body can be exemplified by unwoven fabric, a foam, and a sintered object made of the metal material above, unwoven fabric composed of the polymer material above, and the like. In addition, a plate-shaped body composed of the polymer material or the metal material above and having regular or irregular slit patterns (groove patterns) in a surface as capillaries can also be employed for fuel transportation member 61.

A pore diameter of pores in fuel transportation member 61 is set preferably to 0.1 to 500 μm and more preferably to 1 to 300 μm, in order to achieve a sufficient capillary phenomenon against gravity and to obtain satisfactory suction height (which means a position which liquid fuel can reach in the member owing to the capillary phenomenon at the time when one end of the fuel transportation member is immersed in liquid fuel) and suction rate (which means a volume of liquid fuel suctioned per unit time when one end of the fuel transportation member is immersed in liquid fuel). It is noted that a pore diameter of pores in fuel transportation member 61 is a diameter measured with the mercury intrusion method.

From a point of view of a suction height and a suction rate above, a material exhibiting a capillary action and forming fuel transportation member 61 having a water lift distance after 30 minutes preferably not smaller than 10 cm and more preferably not smaller than 15 cm is employed. Examples thereof include “Hatosheet” manufactured by Oji Kinocloth Co., Ltd. and “Water Conduction Sheet” manufactured by Toray Industries, Inc. The water lift distance means a height which water reaches after a 2-cm long lower end of a felt specimen is immersed in water at a temperature of 25° C. and left for a certain period of time (30 minutes).

A shape of fuel transportation member 61 is not limited to a strip shape (more specifically, a parallelepiped shape) as shown in FIG. 11, and fuel transportation member 61 can have an appropriate shape in accordance with a shape of the fuel cell as a whole, a shape of a membrane electrode assembly, a shape of liquid fuel accommodation portion 60, or the like. Examples of a shape other than the parallelepiped shape include a cubic shape and a strip shape, that is, such a shape that a width continuously or stepwise increases or decreases from one end toward the other end (such a shape that a surface is in a trapezoidal or triangular shape).

A length of fuel transportation member 61 (a distance from one end on the fuel storage portion 70 side to the other end opposed thereto) is not particularly restricted, and fuel transportation member 61 can have an appropriate length in accordance with a shape of the fuel cell as a whole, a shape of a membrane electrode assembly, a shape of liquid fuel accommodation portion 60, or the like. Fuel transportation member 61, however, preferably has a length equal to or longer than such a length that, when one end of fuel transportation member 61 is arranged at a position at which fuel transportation member 61 can be in contact with liquid fuel held in fuel storage portion 70, the other end thereof is arranged at a position substantially directly under an end portion of anode 11 (an end portion opposite to the fuel storage portion 70 side).

It is noted that “a position at which fuel transportation member 61 can be in contact with liquid fuel” includes a case that one end of fuel transportation member 61 is located within fuel storage portion 70 as shown in FIG. 11, a case that one end of fuel transportation member 61 is located in the inside of a wall serving as a partition between liquid fuel accommodation portion 60 and fuel storage portion 70 (which is a part of box housing 40), and the like.

(3) A construction may be such that liquid fuel accommodation portion 60 also serves as fuel storage portion 70 for storing liquid fuel, and fuel storage portion 70 does not have to be provided.

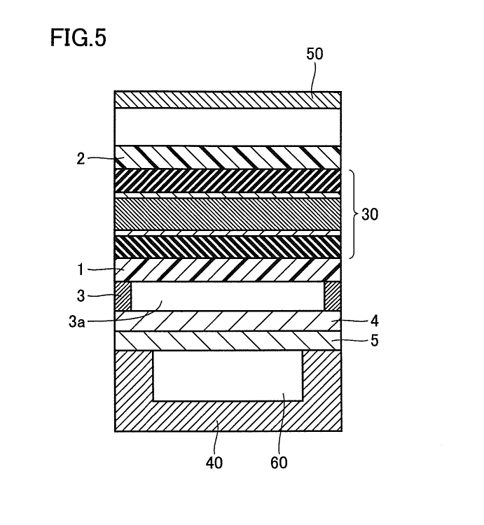

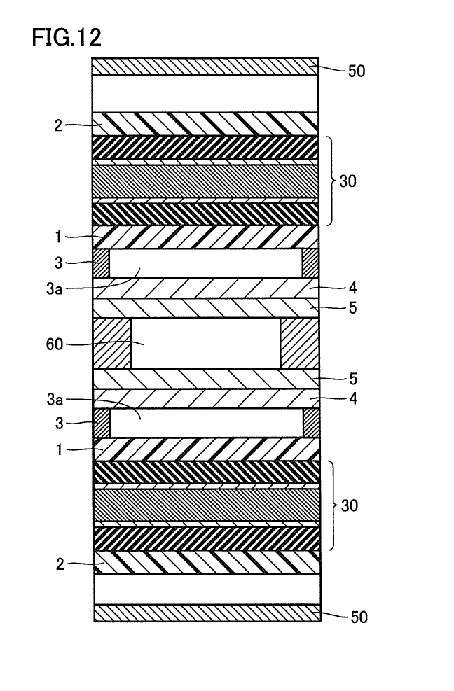

(4) A layered construction of the fuel cell is not limited to those shown in FIGS. 1 to 5, and for example, the construction may be such that unit cell 30 is arranged on each of opposing surfaces of liquid fuel accommodation portion 60 as shown in FIG. 12. FIG. 12 is a schematic cross-sectional view similar to FIG. 5, showing one example of a fuel cell in which unit cell 30 is arranged on each of opposing surfaces of liquid fuel accommodation portion 60. In such a construction, liquid fuel accommodation portion 60 should have upper and lower surfaces, both of which are open in order to supply fuel to two upper and lower anodes 11, and hence a member having a space having open upper and lower surfaces is employed as box housing 40. In such a fuel cell in which unit cell 30 is arranged on each of opposing surfaces of liquid fuel accommodation portion 60, one liquid fuel accommodation portion 60 (box housing 40) is sufficient for two unit cells, and therefore a fuel cell can have a smaller thickness and output per unit volume of a fuel cell can be improved.

(5) An outer shape of a fuel cell is not limited to the shape in the embodiment above. For example, a shape of a fuel cell when viewed in a direction of thickness (a two-dimensional shape) can be in a rectangular shape, a square shape, and the like.

(6) A fuel cell can include delivery means such as a pump, for delivering liquid fuel accommodated in fuel storage portion 70 to liquid fuel accommodation portion 60 (for example, in a case not having first layer 5 or fuel transportation member 61; it is noted that delivery means may be provided together with these members). Since liquid fuel accommodation portion 60 can be filled with liquid fuel in a short period of time by using delivery means, start-up capability of a fuel cell can be improved.

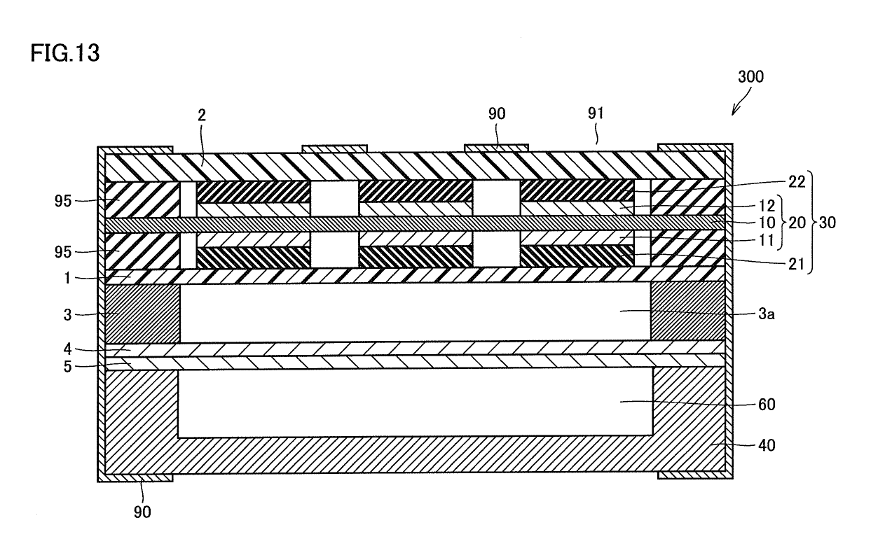

(7) A fuel cell may include two or more unit cells 30 arranged on the same plane. FIG. 13 shows one example of such a fuel cell including a plurality of unit cells 30. A fuel cell 300 shown in FIG. 13 is basically constituted of: a power generation portion constituted by arranging on the same plane, three unit cells 30 each including membrane electrode assembly 20 including anode 11, electrolyte membrane 10, and cathode 12 in this order, anode current collection layer 21 stacked on anode 11, and cathode current collection layer 22 stacked on cathode 12; liquid fuel accommodation portion 60 arranged below the power generation portion (formed from a recess formed in box housing 40); first moisture retention layer 1 stacked on anode current collection layer 21 so as to be in contact therewith; second moisture retention layer 2 stacked on cathode current collection layer 22 so as to be in contact therewith; gas-liquid separation layer 7 arranged over liquid fuel accommodation portion 60 so as to cover an opening of liquid fuel accommodation portion 60 (a two-layered structure of first layer 5 and second layer 4); and vaporized fuel plate 3 having vaporized fuel accommodation portion 3a formed from a space formed between gas-liquid separation layer 7 and first moisture retention layer 1.

A periphery of the power generation portion is sealed with a sealing member 95. Sealing member 95 can be formed of a material similar to that for sealing layer 80 described above. From a point of view of protection of a fuel cell, the fuel cell may be accommodated in an exterior case 90. In a region of exterior case 90 located directly above cathode 12, an opening 91 for taking in an oxidizing agent (such as air) is formed.

In a case that a fuel cell includes a plurality of unit cells 30, the number of unit cells 30 is not particularly restricted. In addition, vaporized fuel accommodation portion 3a and liquid fuel accommodation portion 60 may be provided for each unit cell 30 or they may be provided in number smaller than the number of unit cells 30. In the example shown in FIG. 13, the number of vaporized fuel accommodation portions 3a and liquid fuel accommodation portions 60 is set to one, with respect to the number of unit cells 30 being 3. Similarly, the number of other members may be smaller than the number of unit cells 30, and a plurality of unit cells 30 may share those members. For example, in the example shown in FIG. 13, three unit cells 30 share one first moisture retention layer 1, one second moisture retention layer 2, and one electrolyte membrane 10.

The fuel cell according to the present invention can be a polymer electrolyte fuel cell, a direct alcohol fuel cell, or the like, and particularly it is suitable as a direct alcohol fuel cell (among others, a direct methanol fuel cell). Examples of liquid fuel which can be used in the fuel cell according to the present invention can include: alcohols such as methanol and ethanol; acetals such as dimethoxymethane; carboxylic acids such as formic acid; esters such as methyl formate; and an aqueous solution thereof. The liquid fuel is not limited to liquid fuel consisting of one type, and a mixture of two or more types may be employed. A methanol aqueous solution or pure methanol is preferably employed from a point of view of low cost, high energy density per volume, high power generation efficiency, and the like. According to the present invention, even when high-concentration fuel (a methanol aqueous solution, pure methanol, or the like of which concentration exceeds 50 mol %) is employed, good power generation characteristics can be obtained.

The fuel cell according to the present invention can suitably be employed as a power supply for electronic devices, in particular for small electronic devices such as portable devices represented by a portable telephone, an electronic notepad, and a notebook personal computer.

### EXAMPLES

The present invention will be described hereinafter in further detail with reference to an example, however, the present invention is not limited thereto.

### Example 1

A fuel cell having a construction similar to that in FIG. 1 was fabricated in the following procedure.

(1) Fabrication of Membrane Electrode Assembly

A catalyst paste for an anode was fabricated by placing catalyst carrying carbon particles of which Pt carrying amount was 32.5 weight % and Ru carrying amount was 16.9 weight % (ILC66E50, manufactured by Tanaka Kikinzoku Group), 20 weight % of Nafion® alcohol solution (manufactured by Aldrich Co.) which was an electrolyte, n-propanol, isopropanol, and zirconia balls at a prescribed ratio in a container made of a fluorine-based resin and mixing these with the use of a stirrer at 500 rpm for 50 minutes. In addition, a catalyst paste for a cathode was fabricated as in the case of the catalyst paste for the anode, except for use of catalyst carrying carbon particles of which Pt carrying amount was 46.8 weight % (TEC10E50E, manufactured by Tanaka Kikinzoku Group).

Then, carbon paper (25BC, manufactured by SGL) having a porous layer having water-repellency formed on one surface was cut to a size of 23 mm long and 28 mm wide, and thereafter the catalyst paste for the anode above was applied onto the porous layer with the use of a screen printing plate having a window of a size of 22 mm long and 27 mm wide such that a catalyst carrying amount was approximately 3 mg/cm² followed by drying. Anode 11 having a thickness of approximately 100 μm and having an anode catalyst layer formed in the center on the carbon paper which was an anode conductive porous layer was thus fabricated. In addition, the catalyst paste for the cathode above was applied onto a porous layer of carbon paper of the same size with the use of a screen printing plate having a window of a size of 22 mm long and 27 mm wide such that a catalyst carrying amount was approximately 1 mg/cm² followed by drying. Cathode 12 having a thickness of approximately 50 μm and having a cathode catalyst layer formed in the center on the carbon paper which was a cathode conductive porous layer was thus fabricated.

Then, a perfluorosulfonic-acid-based ion-exchange membrane having a thickness of approximately 175 μm (Nafion® 117 manufactured by Du Pont) was cut to a size of 23 mm long and 28 mm wide, which was employed as electrolyte membrane 10. Anode 11, electrolyte membrane 10, and cathode 12 were layered in this order such that a catalyst layer of each of them faced electrolyte membrane 10, followed by thermocompression at 130° C. for 2 minutes. Anode 11 and cathode 12 were thus bonded to electrolyte membrane 10. Layering above was carried out such that a position of anode 11 in a plane of electrolyte membrane 10 and a position of cathode 12 therein coincided with each other and centers of anode 11, electrolyte membrane 10, and cathode 12 coincided with one another. Then, by cutting an outer peripheral portion of the obtained stack structure, membrane electrode assembly 20 having a size of 22 mm long and 27 mm wide was fabricated.

(2) Fabrication of Unit Cell

A stainless plate (NSS445M2, manufactured by Nisshin Steel Co., Ltd.) having a size of 22 mm long, 27 mm wide, and 0.1 mm thick was prepared, and a plurality of open holes having an open hole diameter φ of 0.6 mm (an open hole pattern: a staggered 60° pitch of 0.8 mm) were worked in a central region thereof from opposing surfaces with wet etching with the use of a photoresist mask. Thus, two stainless plates including a plurality of through holes passing through in a direction of thickness were fabricated, and these were adopted as anode current collection layer 21 and cathode current collection layer 22.

Then, anode current collection layer 21 was stacked on anode 11 with a conductive adhesive layer composed of carbon particles and an epoxy resin being interposed, cathode current collection layer 22 was stacked on cathode 12 with a conductive adhesive layer composed of carbon particles and an epoxy resin being interposed, and they were bonded through thermocompression. Thus, unit cell 30 having a size of 22 mm long and 27 mm wide was fabricated. It is noted that anode current collection layer 21 and cathode current collection layer 22 were stacked such that regions having their open holes formed are arranged directly above anode 11, cathode 12, respectively.

(3) Bonding of First and Second Moisture Retention Layers

Two porous films composed of polytetrafluoroethylene (“TEMISH® NTF2122A-S06” manufactured by Nitto Denko Corporation, having a size of 25 mm long, 27 mm wide, and 0.2 mm thick and a porosity of 75%) were prepared as first moisture retention layer 1 and the second moisture retention layer. These moisture retention layers were stacked on anode current collection layer 21 and cathode current collection layer 22 of unit cell 30, respectively, with an adhesive layer composed of polyolefin being interposed, and they were bonded through thermocompression.

(4) Fabrication of Gas-Liquid Separation Layer

A porous film composed of polyvinylidene fluoride having a size of 25 mm long, 27 mm wide, and 0.1 mm thick (Durapore membrane filter manufactured by Millipore Corporation) was employed as first layer 5 of gas-liquid separation layer 7. A maximum pore diameter of pores in this porous film was 0.1 μm and a bubble point in conformity with JIS K 3832 was 115 kPa, with methanol being adopted as a measurement medium.

In addition, a porous film composed of polytetrafluoroethylene (“TEMISH® NTF2122A-S06” manufactured by Nitto Denko Corporation) having a size of 25 mm long, 27 mm wide, and 0.2 mm thick was employed as second layer 4 of gas-liquid separation layer 7. A bubble point of this porous film in conformity with JIS K 3832 was 18 kPa, with methanol being adopted as a measurement medium.

Second layer 4 was stacked on first layer 5 and a layer boundary portion around all side surfaces was bonded with an adhesive, to thereby fabricate gas-liquid separation layer 7.

(5) Bonding Between Vaporized Fuel Plate and Gas-Liquid Separation Layer Vaporized fuel plate 3′ made of SUS and having a shape shown in FIG. 7 and a size of 25 mm long, 27 mm wide, and 0.2 mm thick was fabricated through an etching process (communication path 3b′ and connection paths 3c′, 3d′ were all formed from grooves (recesses)). An opening ratio of four through ports 3a′ in total was 63% and a ratio between a total cross-sectional area of two communication paths 3b′ and a total area of side surfaces of the vaporized fuel plate was 0.04. Gas-liquid separation layer 7 was stacked on a surface opposite to a surface where a groove of vaporized fuel plate 3′ was formed such that its second layer 4 side faced vaporized fuel plate 3′, and these were bonded through thermocompression.

(6) Fabrication of Liquid Fuel Accommodation Portion

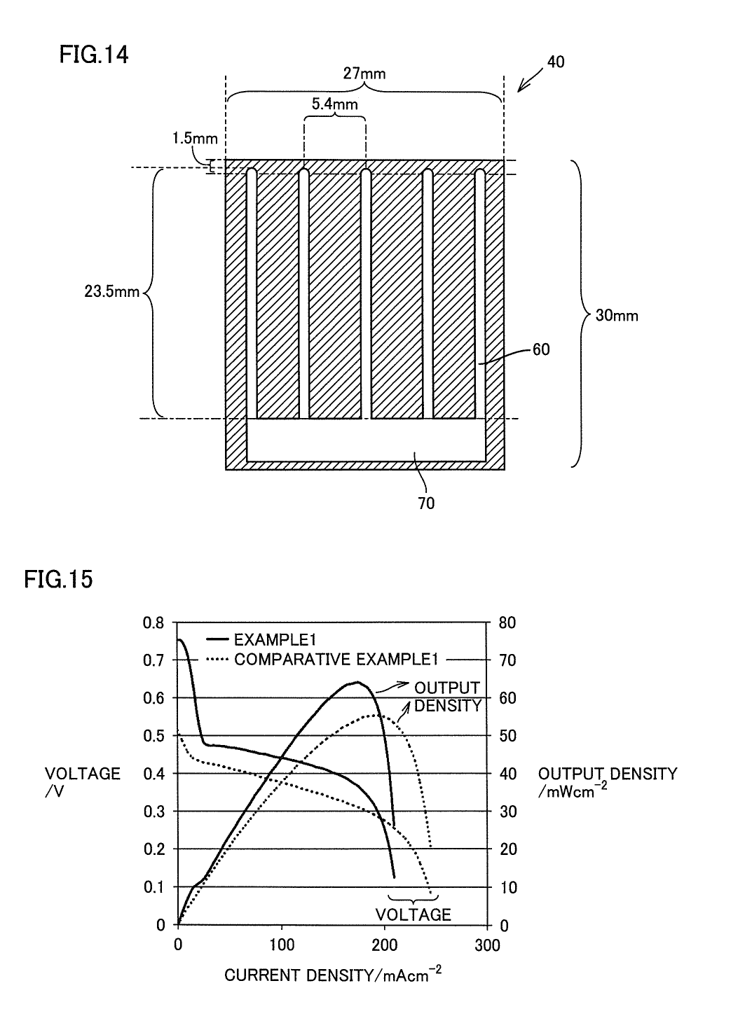

Box housing 40 having a size of 30 mm long, 27 mm wide, and 0.6 mm thick and having 5 recesses (spaces serving as liquid fuel accommodation portion 60) each having a size of 23.5 mm long, 1.0 mm wide, and 0.4 mm deep formed in one surface as shown in FIG. 14 was prepared. This box housing 40 has a shape the same as that shown in FIG. 1, and it includes a recess forming fuel storage portion 70, lateral to the recesses serving as liquid fuel accommodation portion 60. After the stack structure of vaporized fuel plate 3′ and gas-liquid separation layer 7 was stacked over the recesses in box housing 40 with a polyolefin-based adhesive such that the first layer 5 side of the stack structure was located on the box housing 40 side, thermocompression was carried out so as to bond the stack structure and box housing 40 to each other.

(7) Fabrication of Fuel Cell

Unit cell 30 having the moisture retention layer was stacked on vaporized fuel plate 3′ and bonded thereto through thermocompression. An epoxy resin was applied to side surfaces of unit cell 30, moisture retention layers 1, 2, vaporized fuel plate 3′, and gas-liquid separation layer 7 on the fuel storage portion 70 side and was cured to thereby form sealing layer 80 (a fuel entry prevention layer). Finally, lid housing 50 including openings 51 for supplying air to cathode 12 and second open hole 71 (a pressure regulation hole) was arranged on second moisture retention layer 2, to thereby obtain a fuel cell.

### Comparative Example 1

A fuel cell was fabricated as in Example 1 except for not having first moisture retention layer 1 (but having second moisture retention layer 2).

### [Evaluation of Performance of Fuel Cell: Output Characteristics (I-V Characteristics) of Fuel Cells in Example 1 and Comparative Example 1

A methanol aqueous solution having a methanol concentration of 17 M was employed as fuel, fuel was supplied through passive supply, the fuel cell was operated, and output characteristics of the fuel cell were evaluated by using a charge and discharge apparatus (“SPEC20526” manufactured by Kikusui Electronics Corp.) and conducting I-V measurement. FIG. 15 is a diagram showing output characteristics of the fuel cells fabricated in Example 1 and Comparative Example 1. As shown in FIG. 15, the fuel cell in Example 1 exhibited good output characteristics and obtained maximum output density of approximately 65 mW/cm². On the other hand, in the fuel cell in Comparative Example 1, a degree of lowering in voltage at the time when current density was gradually increased was greater than that in Example 1 and maximum output density also lowered.

### REFERENCE SIGNS LIST

1 first moisture retention layer; 2 second moisture retention layer; 3, 3′ vaporized fuel plate; 3a, 3a′ vaporized fuel accommodation portion (through port); 3b, 3b′ communication path; 3c′, 3d′ connection path; 4 second layer; 5 first layer; 6 third layer; 7 gas-liquid separation layer; 10 electrolyte membrane; 11 anode; 12 cathode; 20 membrane electrode assembly; 21 anode current collection layer; 22 cathode current collection layer; 30 unit cell; 40 box housing; 50 lid housing; 51 opening; 60 liquid fuel accommodation portion; 61 fuel transportation member; 63 first open hole; 70 fuel storage portion; 71 second open hole; 80 sealing layer; 90 exterior case; 91 opening; 95 sealing member; and 100, 200, 300 fuel cell.

1. A fuel cell, comprising:
a unit cell having an anode, an electrolyte membrane, and a cathode in this order;
a liquid fuel accommodation portion composed of a space opening on a side of said anode and arranged on the side of said anode, for accommodating or allowing flow of liquid fuel; and
a first moisture retention layer arranged between said unit cell and said liquid fuel accommodation portion.

2. The fuel cell according to claim 1, further comprising a second moisture retention layer arranged on said cathode.

3. The fuel cell according to claim 1, wherein
said unit cell further includes an anode current collection layer stacked on said anode and a cathode current collection layer stacked on said cathode.

4. The fuel cell according to claim 3, wherein
said first moisture retention layer is arranged on said anode current collection layer so as to be in contact with said anode current collection layer.

5. The fuel cell according to claim 3, further comprising a second moisture retention layer arranged on said cathode, wherein
said second moisture retention layer is arranged on said cathode current collection layer so as to be in contact with said cathode current collection layer.

6. The fuel cell according to claim 3, further comprising a second moisture retention layer arranged on said cathode, wherein
said first moisture retention layer is arranged on said anode current collection layer so as to be in contact with said anode current collection layer, and
said second moisture retention layer is arranged on said cathode current collection layer so as to be in contact with said cathode current collection layer.

7. The fuel cell according to claim 1, further comprising:
a gas-liquid separation layer arranged over said liquid fuel accommodation portion so as to cover an opening of said liquid fuel accommodation portion and allowing a vaporized component of said liquid fuel to permeate; and
a vaporized fuel accommodation portion composed of a space formed between said gas-liquid separation layer and said first moisture retention layer.

8. The fuel cell according to claim 7, wherein
said gas-liquid separation layer has a two-layered structure constituted of a first layer arranged over said liquid fuel accommodation portion so as to cover the opening of said liquid fuel accommodation portion and having a bubble point not lower than 30 kPa with methanol being adopted as a measurement medium and a second layer stacked on a surface of said first layer on a side of the unit cell and allowing a vaporized component of said liquid fuel to permeate.

9. The fuel cell according to claim 1, wherein
the fuel cell is a direct alcohol fuel cell.

10. The fuel cell according to claim 9, wherein
said liquid fuel is pure methanol or a methanol aqueous solution.
